(19) United States
(12) Patent Application Publication
(10) Pub. No.: US 2019/0279435 A1
(43) Pub. Date: Sep. 12, 2019

(54) TRANSPORT DOCUMENT DISTRIBUTION SYSTEM AND ASSOCIATED METHOD

(71) Applicant: FLOWBIRD, Paris (FR)

(72) Inventor: Pierre KLEIN, DEVECEY (FR)

(21) Appl. No.: 16/294,000

(22) Filed: Mar. 6, 2019

(30) Foreign Application Priority Data
Mar. 7, 2018 (FR) 18 51947

(51) Int. Cl. G07B 15/00; G06Q 20/18

(52) U.S. Cl. CPC G07B 15/00; G06K 19/06037; G06Q 20/18

(57) ABSTRACT

A transport document distribution system includes a first payment terminal on the road for sale and delivery of parking documents associated with a right to a parking place and a second piece of equipment. The payment terminal provides, to a user, a list of selectable transport documents, detecting the user selection of a transport document, implementing user payment of the selected transport document and delivering to the user, in response to the payment, an identifier of the transport title. The second piece of equipment requests, from a user, the provision of a transport document identifier, in order to receive an identifier supplied by the user and previously delivered by a first piece of equipment, in order to determine, as a function of the received identifier, the transport document having previously been selected and paid for by the user and to deliver the transport document to the user.

### TECHNICAL FIELD

The present invention relates to the field of transport document distribution.

### BACKGROUND

Today, the users of automatic transport document sales machines must often stand in line to use these machines, for example at the end of the month or the beginning of the month, or in some concentrated areas such as train stations receiving travelers from elsewhere who are required to obtain a transport document to continue their travel.

These machines generally allow users to perform the selection operations of a transport document from among several that are proposed, allow the user to pay for a selected document, and also make it possible to provide the transport document to the user. They are often very quick to ultimately supply the transport document by printing (often 10 tickets can be printed in less than 10 seconds) or by (re)loading digital data on an electronic medium presented by the user or stored in the automaton.

### SUMMARY

The aim of the invention is to propose a transport document distribution system that makes it possible to improve the processing time necessary to supply users with transport documents.

To that end, according to a first aspect, the invention proposes a transport document distribution system characterized in that it comprises:
a first set of equipment comprising one or several first pieces of equipment including one or several payment terminal(s) arranged on the road and usable for at least the sale and delivery of at least parking documents each associated with a parking right to a parking place; and
a second set of equipment comprising one or several second piece(s) of equipment;
wherein each first piece of equipment of the first set of equipment comprises a first man-machine interface suitable for providing, to a user of said equipment, a list of selectable transport document(s), detecting a selection by the user of a transport document from the list, implementing the payment by the user of the selected transport document and delivering to said user, in response to said payment, an identifier of said transport title; and
wherein each second piece of equipment of the second set of equipment comprises a second man-machine interface suitable for requesting, from a user, the provision of a transport document identifier, in order to receive an identifier supplied by said user and previously delivered by a first piece of equipment, in order to determine, as a function of said received identifier, the transport document having previously been selected and paid for by the user and to deliver said transport document to said user.

The invention thus makes it possible to decrease the waiting time of travelers to obtain their transport document and reduce the length of waiting lines at transport document distribution machines: the flow of travelers in public transportation stations, in particular subway, train, bus are thus regulated and optimized.

The transport document distribution machines are used primarily for document distribution operations, the selection and payment operations being performed on other equipment and in particular on payment terminals delivering parking tickets.

In embodiments, the transport document distribution system according to the invention further includes one or more of the following features:
the second man-machine interface of the second piece of equipment is suitable for delivering said transport document in a form from among a printed transport document, a card with or without an electronic chip, a reloading, with or without contact, of digital data of an electronic device presented to the interface by the user;
the first set of equipment further includes at least one first piece of equipment from among: a mobile telephone, a personal computer and a fixed machine for selecting and paying for transport documents arranged in a transport station;
a first piece of equipment is suitable for delivering an identifier including at least one element from among a barcode, a two-dimensional barcode, an identifier indicating, aside from the selected transport title, the moment of the payment.

According to a second aspect, the present invention proposes a payment terminal intended to be arranged on the road and usable for at least the sale and delivery of at least parking documents each associated with a parking right to a parking place, said terminal comprising a first man-machine interface suitable for providing, to a user, a list of selectable transport document(s), detecting a selection by the user of a transport document from the list, implementing the payment by the user for the selected transport document and delivering, to said user, in response to said payment, an identifier of said transport document.

According to a third aspect, the present invention proposes a method for distributing transport documents in a transport document distribution system comprising:
a first set of equipment comprising one or several first pieces of equipment including one or several payment terminal(s) arranged on the road and usable for at least the sale and delivery of at least parking documents each associated with a parking right to a parking place; and
a second set of equipment comprising one or several second piece(s) of equipment;
said method being characterized in that it comprises the following steps:
   provision by each first piece of equipment of the first set of equipment to a user of said equipment, of a list of selectable transport document(s),
   detection by said first piece of equipment of a selection by the user of a transport document from the list,
   implementation by the first piece of equipment of the payment by the user for the selected transport document and delivery by the first piece of equipment to said user, in response to said payment, of an identifier of said transport document;
   request, by a second piece of equipment of the second set of equipment, for the provision of a transport document identifier,
   reception by the second piece of equipment of an identifier provided by a user and previously delivered by the first piece of equipment,
   determination by the second piece of equipment, as a function of said received identifier, of the transport title having previously been selected and paid for,
   delivery by the second piece of equipment to said user of said transport title.

### BRIEF DESCRIPTION OF THE DRAWINGS

These features and advantages of the invention will appear upon reading the following description, provided solely as an example, and done in reference to the appended drawings, in which:

FIG. 1 shows a view of a transport document distribution system in one embodiment of the invention;

FIG. 2 is a view of a flowchart of steps implemented in one embodiment of the invention.

### DETAILED DESCRIPTION

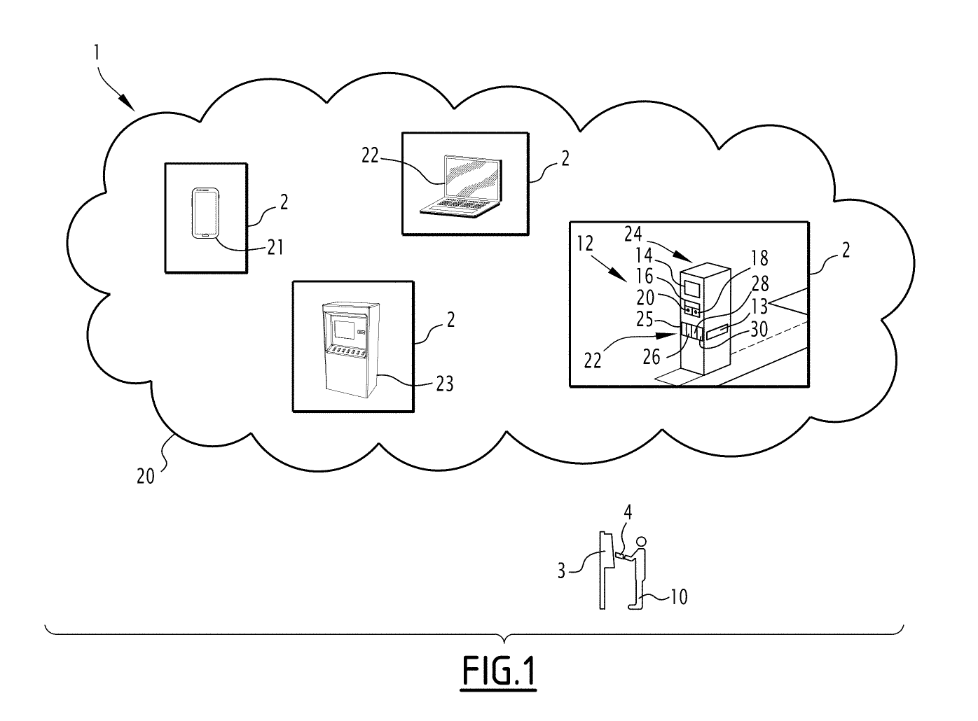

FIG. 1 shows a schematic view of a transport document distribution system 1 in one embodiment of the invention.

The transport document distribution system 1 comprises a first set 20 of equipment 2. These pieces of equipment 2 are each suitable, in particular via a man-machine interface with which they are equipped, for:

providing a user of said equipment with a list of selectable transport document(s),

allowing the user to select, on the piece of equipment 2, a transport document from among these and detecting a selection by the user of a transport document from the list,

implementing the payment by the user for the selected transport document, and

delivering to said user, in response to said payment, an identifier of said transport document.

A piece of equipment 2 is for example a mobile telephone 21 of a user, a computer of a user, a transport document selection machine 23 arranged in a public location such as a train station, bus station, tram, subway, a payment terminal 24 for the sale and delivery of at least parking documents, also called parking meter, etc.

The invention will be described more specifically relative to a piece of equipment 2 of the parking meter 24 type, but the functions relative to the presentation, selection and payment of the transport document, as well as the provision of an identifier of the transport document are performed similarly by the other types of equipment 2.

The transport document distribution system 1 comprises a second set of distribution equipment 3, a single piece of equipment 3 having been shown in FIG. 3. Some of these pieces of distribution equipment 3 are in particular installed in train stations, subway stations, trams, etc.

The parking meter 24 is a payment terminal usable, in a known manner, for the sale and delivery of at least parking documents each associated with a parking right to a parking place until a cutoff time authorized by the parking document.

FR 2,968,814 A1 discloses an example of a parking meter. Parking meters 24 are freely accessible, arranged on the road, and for example distributed throughout a city. The “road” comprises the roadway reserved for car traffic, parking places reserved for parking by vehicles, and sidewalks and pedestrian spaces reserved for pedestrian traffic.

According to one embodiment of the invention, the parking meter 24 further contributes to the obtainment of a transport document by the user in the manner indicated hereinafter.

A transport document is a document that allows an individual to prove payment for his journey when this individual uses the transport means authorized by said transport document (for example subway, tram, city bus); the transport document may also make it possible, when it is valid, to unlock barriers preventing access to these transport means.

In the present document, a “user” designates a person using a piece of equipment 2, for example a parking meter 24, of the transport document distribution system 1, in order to obtain such a transport document.

Each parking meter 24 comprises a first man-machine interface device 12 allowing the user to interact with the parking meter 24 in particular in order to obtain a parking document or to obtain, according to the invention, a parking document identifier.

The first man-machine interface device 12 for example comprises a data display device 14, a pointing device 16 for selecting fields in a user graphic interface, an alphanumeric keypad 18 for entering alphanumeric characters and/or one or several physical buttons 20. The display device 14 is for example a touch-sensitive screen to make it possible to point and/or to enter data directly on the screen.

Each parking meter 24 further comprises a storage unit 13, suitable for storing parking document or parking right definition elements used by the parking meter 24.

The first man-machine interface device 12 is suitable for extracting, from the storage unit 13, and displaying, on the data display device 14 for the users, the parking right elements, for the selection of a parking duration for the delivery of a parking document corresponding to the selection.

The first man-machine interface device 12 is further suitable for extracting, from the storage unit 13, the elements relative to the transport documents, to determine, as a function of said elements, then to display on the data display device 14 for the users, a list of the selectable transport documents and the respective prices, for the selection of at least one transport document by the user.

Each parking meter 24 comprises a processing device 22 making it possible to define and deliver, to a user, a parking document via the parking meter 24. The parking document 4 for example indicates a maximum parking cutoff time and a price. The processing device 22 is suitable for determining such a maximum parking cutoff time and said price, as a function of the elements of the parking right stored by the storage unit 13, and for example in the considered case, further as a function of the current time, and the provision by the user, via the first man-machine interface device 12, of a parking duration.

The processing device 22 in particular comprises a microprocessor and a memory storing software instructions, which, when executed on the microprocessor, define the operation of the processing device 22.

The processing device 22 is further suitable, as a function of one or several transport documents selected by the user via the first man-machine interface device 12 from the list of presented selectable transport documents, for determining a list of transport documents currently selected by the user and a total price equal to the sum of the individual prices of the selected transport documents.

In one embodiment, the processing device 22 is additionally suitable, when the user has selected one or several transport document(s) and further a parking document, for determining a list of transport and parking documents currently selected by the user and a total price equal to the sum of the individual prices of the selected transport and parking documents.

The processing device 22 is further suitable for allowing the payment by the user for the parking document and/or transport documents thus defined: it thus for example comprises an electronic payment terminal 25 configured for payment by card, in particular chip card, in particular by private or bank card, a coin selector 26 configured for payment with one or several coins, a banknote reader 28 configured for payment with one or several banknotes and/or a contactless payment terminal 30 configured for payment with an electronic device (chip card, smartphone, etc. of the user) with contactless communication between the contactless payment terminal and the electronic device, for example by near field communication (NFC).

Each parking meter 24 comprises a printing device 32 suitable for printing a parking ticket when a parking document has been purchased and for printing a receipt when the user has purchased one or more transport documents in embodiments.

The processing device 22 is further suitable, in response to the payment by the user for a transport document, for determining an identifier of the purchased transport document. Then, the parking meter 24 is suitable for delivering the identifier thus determined to the user.

The identifier is intended to be able to make it possible for the distribution equipment 3 responsible for delivering the transport document based on said identifier, later to be able to determine which transport document it must deliver and further to certify that the identifier is indeed from a piece of equipment 2 of the first set 20 of equipment and that the transport document has been paid for.

The identifier is for example obtained by encryption using a security key shared between the pieces of equipment 2 and 3 and stored in a memory of each of said pieces of equipment, resulting from the concatenation of a number identifying the type of transport document purchased, and/or the date and time of purchase and/or an identifier number of the parking meter 24 and/or the validity period of the transport document, and/or the name of the individual for whom said ticket is intended, etc.

The identifier for example takes the form of a sequence of numbers and/or letters, a barcode in 1 dimension or 2 dimensions, etc.

The parking meter 24 is suitable for delivering the identifier for example:
by display on the data display device 14; and/or
by printing by the printing device 32 of a receipt including said identifier; and/or
by sending a message intended for an email address or a telephone of the user (in this case, the parking meter 24 is provided with a remote transmission interface connecting it to a telecommunications network).
by Bluetooth beacon (https://blog.pandasuite.com/fr/articles/technologie-beacon)

The distribution equipment 3 is a transport document distribution machine. It comprises, in a manner not shown in the figures, a second man-machine interface device allowing the user to interact with the piece of equipment 3 in particular in order to obtain a transport document. For example, this second man-machine interface of the distribution machine 3 comprises elements similar to those of the first man-machine interface device 12 of the parking meter 24. It may further comprise a barcode reader, Bluetooth reader, bank card reader, contactless card reader (to recover the identifier), etc. and a connection to a remote server.

The piece of equipment 3 further comprises a storage unit, suitable for storing definition elements of the transport documents, in particular those making it possible to identify, as a function of an identifier provided by a user and previously delivered by a parking meter 24, the type of transport document corresponding to said identifier.

Each piece of equipment 3 comprises a processing device in particular comprising a microprocessor and a memory storing software instructions, which, when executed on the microprocessor, define the operation of the processing device. This processing device of the piece of equipment 3 is further suitable, as a function of an identifier of a transport document provided by the user via the second man-machine interface device and as a function of data stored in the storage unit (in particular in embodiments a decryption key), for determining whether said identifier indeed corresponds to a transport document purchased from a piece of equipment 2 and, if so, to what transport document it corresponds.

Each piece of equipment 3 comprises a distribution device that for example comprises:
a printing unit suitable for printing a transport document when a transport document has been purchased; and/or
a card distribution unit generating, from blank cards and as a function of information present in the identifier and in the storage unit, a valid transport document corresponding to the purchased transport document of the magnetic card or chip card type;
a reloading unit for electronic chip devices, for example chip cards or mobile telephones, suitable for reloading an electronic chip device presented by the user with the data corresponding to a purchased transport document.

The processing device of the equipment 3 is suitable, when it has been determined that an identifier indeed corresponds to a transport document purchased from a piece of equipment 2 and it has further been determined to what transport document it corresponds (i.e., what duration, what perimeter, what medium from among paper, card, card reload, etc.), for ordering the distribution device corresponding to the document and providing it with the elements necessary for the distribution of the purchased document.

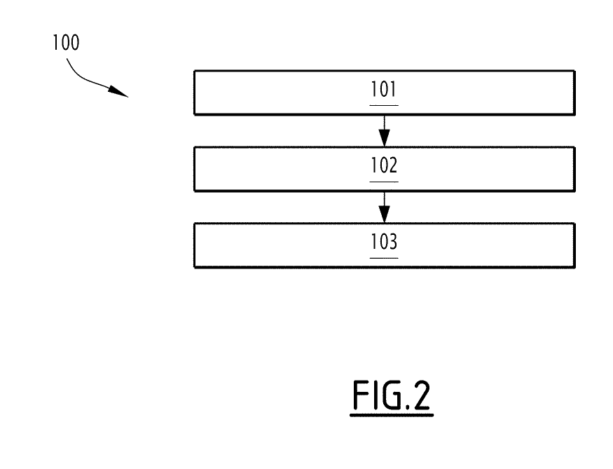

The steps of a method for distributing transport documents in a transport document distribution system 1 are now described in one embodiment, in reference to FIG. 2.

In a step 101, a user 10 wishing to purchase a transport document goes to a parking meter 24. He indicates, via the first man-machine interface device 12, that he wishes to obtain the list of transport documents. The man-machine interface device 12 then extracts, from the storage unit 13, the elements relative to the transport documents; determines, as a function of these elements, the content of said list; then displays the selectable transport documents and their respective prices on the display device 14. The user 10 selects, from among the list of transport documents on the display device 14, that (or those) of the desired document(s), using the pointing device 16 or the alphanumeric keyboard 18 or physical buttons 20.

The processing device 22, as a function of the transport document(s) selected by the user, detects the list of transport documents currently selected by the user and determines an overall price equal to the sum of the individual prices of the selected transport documents.

In a step 102, the first man-machine interface device 12 proposing several payment means, the user 10 selects the desired payment means and then makes the payment for the transport document(s) with said selected payment means.

The processing device 22, in response to the payment by the user for a transport document, determines an identifier of the purchased transport document and the parking meter 24 delivers the identifier thus determined to the user, for example in the form of a printed receipt indicating said identifier.

In a step 103, the user 10 will next obtain this transport document from a piece of distribution equipment 3, hereinafter called distribution machine 3, for example in the manner indicated below.

First of all, the user 10 provides the machine 3 with the identifier previously delivered in step 101, for example by entering the identifier via the keyboard of the second man-machine interface device of the machine 3, or placing the barcode opposite a barcode reader. The processing device of the machine 3 then determines, as a function of said identifier, whether said identifier indeed corresponds to a transport document purchased from a piece of equipment 2, and if so, to what transport document it corresponds. Then, the processing device of the machine 3, when it has determined that the identifier indeed corresponds to a transport document purchased from a piece of equipment 2 and it has further been determined to what transport document it corresponds (i.e., what duration, what perimeter, what medium from among paper, card, card reload, etc.), orders that of the distribution devices corresponding to the medium of the purchased document (for example here, the chip card reloading unit) and provides it with the elements necessary to distribute the purchased document. Then, via the second man-machine interface device, the user 10 is asked to present his transport chip card 4 on a support of the machine, and the chip card reloading unit is suitable for reloading the card with data corresponding to the transport document, by NFC (Near Field Communication) link, for example.

In embodiments, the parking meter 24 and/or the piece of distribution equipment 3 are connected by means of a telecommunication network 8 to a computer server. They then comprise a communication interface configured to implement communications with the computer server via the telecommunication network. The telecommunication network is a wired or wireless telecommunication network: for example, a wired telephone network, a mobile telephone network (GSM, UMTS, LTE), a computer network (LAN, WAN), the Internet, a local network (Wi-Fi, Bluetooth, NFC), etc. In such a case, the transport document or parking right definition elements used by the parking meter 24 and indicated above as being extracted from a storage unit 13 are for example delivered by the server.

In one embodiment, the parking meter 24 sends the server each new identifier that it has delivered to a user. Additionally, each piece of distribution equipment 3, when it receives an identifier provided by a user, makes a request to the server to verify that said identifier has not already been used by a piece of distribution equipment to distribute a transport document, then if the server confirms that it has not been used, the piece of distribution equipment 3 delivers the corresponding transport document to the user, then indicates to the server that the document corresponding to the identifier has been provided, after which the server records, in correspondence with the identifier, that the latter has already been used.

Other types of identifiers can be used in embodiments of the invention:
this can be a unique identifier obtained on the remote server (when the parking meter is connected to a remote server as indicated above);
this can be a unique identifier of the bank card of the user (which may or may not have been used for payment) read on said medium.
many programming languages are able to provide unique identifiers, either from random numbers, or from the time of the system in microseconds or another unit, or from physical elements such as serial numbers of components recorded in the hardware and able to be consulted by the software, etc., or by concatenation of several non-unique elements, but the combination of which is unique; in such a case, the identifier and definition elements of the transport document are for example provided by the parking meter to the remote server, which will in turn be addressed by the distribution machine to obtain these definition elements corresponding to an identifier that will have been presented to it by a user.

The selection of the transport document and the provision of the identifier have been described above as being implemented from a parking meter. These operations can also, as already indicated, be implemented from other types of equipment 2, for example mobile telephone, computer: either by executing an application previously downloaded from the Internet, for example, or by connecting via the web browser of the piece of equipment 2 to a website for issuing transport documents associated with the system 1 and thus offering to the user to implement, by HTML pages, by exchanging with the site, the selection, payment, then provision of the identifier from the man-machine interface offered by said pieces of equipment 2. The payment then takes place by online payment means traditionally used on the Internet, for example by providing numbers appearing on the payment card, or via a buffer account, such as “PayPal®”, etc.

The present invention thus makes it possible to significantly shed the workload borne by the machines responsible for distributing transport documents, since they are primarily dedicated to this use, all of the upstream selection and payment operations being able to be done in parallel on other pieces of equipment. The invention therefore makes it possible to have simplified distribution terminals (dedicated to distribution only, for example, not allowing selection or payment) and separate terminals for product selection and sales, which do not distribute documents and can be distributed in train stations in particular as “satellite” terminals.

It will be noted that the invention has been described above in reference to urban transport (subway, tram, bus, etc.), but the invention is applicable to any type of transport, for example transport by rail, air transport, etc.

1. A transport document distribution system including :
a first set of equipment comprising one or several first pieces of equipment including one or several payment terminal(s) arranged on the road and usable for at least the sale and delivery of at least parking documents each associated with a parking right to a parking place; and
a second set of equipment comprising one or several second piece(s) of equipment;
wherein each first piece of equipment of the first set of equipment comprises a first man-machine interface suitable for providing, to a user of said equipment, a list of selectable transport document(s), detecting a selection by the user of a transport document from the list, implementing the payment by the user of the selected transport document and delivering to said user, in response to said payment, an identifier of said transport title; and
wherein each second piece of equipment of the second set of equipment comprises a second man-machine interface suitable for requesting, from a user, the provision of a transport document identifier, in order to receive an identifier supplied by said user and previously delivered by a first piece of equipment, in order to determine, as a function of said received identifier, the transport document having previously been selected and paid for by the user and to deliver said transport document to said user.

2. The transport document distribution system according to claim 1, wherein the second man-machine interface of the second piece of equipment is suitable for delivering said transport document in a form from among a printed transport document, a card with or without an electronic chip, a reloading, with or without contact, of digital data of an electronic device presented to the interface by the user.

3. The transport document distribution system according to claim 1, wherein the first set of equipment further includes at least one first piece of equipment from among: a mobile telephone, a personal computer and a fixed machine for selecting and paying for transport documents arranged in a transport station.

4. The transport document distribution system according to claim 1, wherein a first piece of equipment is suitable for delivering an identifier including at least one element from among a barcode, a two-dimensional barcode, an identifier indicating, aside from the selected transport title, the moment of the payment.

5. A payment terminal, intended to be arranged on the road and usable for at least the sale and delivery of at least parking documents each associated with a parking right to a parking place, said terminal comprising a first man-machine interface suitable for providing, to a user, a list of selectable transport document(s), detecting a selection by the user of a transport document from the list, implementing the payment by the user for the selected transport document and delivering, to said user, in response to said payment, an identifier of said transport document.

6. The payment terminal according to claim 5, suitable for delivering an identifier including at least one element from among a barcode, a two-dimensional barcode, an identifier indicating, aside from the selected transport title, the moment of the payment.

7. A method for distributing transport documents in a transport document distribution system comprising:
a first set of equipment comprising one or several first pieces of equipment including one or several payment terminal(s) arranged on the road and usable for at least the sale and delivery of at least parking documents each associated with a parking right to a parking place; and
a second set of equipment comprising one or several second piece(s) of equipment ;
said method comprising the following steps:
provision by each first piece of equipment of the first set of equipment to a user of said equipment, of a list of selectable transport document(s),
detection by said first piece of equipment of a selection by the user of a transport document from the list,
implementation by the first piece of equipment of the payment by the user for the selected transport document and delivery by the first piece of equipment to said user, in response to said payment, of an identifier of said transport document;
request, by a second piece of equipment of the second set of equipment, for the provision of a transport document identifier,
reception by the second piece of equipment of an identifier provided by a user and previously delivered by the first piece of equipment,
determination by the second piece of equipment, as a function of said received identifier, of the transport title having previously been selected and paid for,
delivery by the second piece of equipment to said user of said transport title.

8. The method for distributing transport documents according to claim 7, wherein the transport document is issued in a form from among a printed transport document, a card with or without an electronic chip, a reloading, with or without contact, of digital data of an electronic device presented to the interface by the user.

9. The method for distributing transport documents according to claim 7, wherein the first set of equipment further includes at least one first piece of equipment from among: a mobile telephone, a personal computer and a fixed machine for selecting and paying for transport documents arranged in a transport station.

10. The method for distributing transport documents according to claim 7, wherein the issued identifier includes at least one element from among a barcode, a two-dimensional barcode, an identifier indicating, aside from the selected transport title, the moment of the payment.
